(19) United States
(12) Patent Application Publication
(10) Pub. No.: US 2015/0339658 A1
(43) Pub. Date: Nov. 26, 2015

(54) METHOD OF AUTHENTICATION BETWEEN A MOBILE TERMINAL AND A PROCESSING TERMINAL

(71) Applicant: Orange, Paris (FR)

(72) Inventors: Patrick LEROY, Saint Manvieu - Norrey (FR); Emmanuel MAYER, IFS (FR)

(21) Appl. No.: 14/410,665

(22) PCT Filed: Jun. 25, 2013
(86) PCT No.: PCT/FR2013/051475

§ 371 Date: Dec. 23, 2014

(30) Foreign Application Priority Data
Jun. 25, 2012 (FR) 1255992

(51) Int. Cl. G06Q 20/32; G06Q 20/26; G06Q 20/40; G06Q 20/10; G06F 21/31; H04W 12/06

(52) U.S. Cl. CPC G06Q 20/3226; G06F 21/31; H04W 12/06; G06Q 20/40; G06Q 20/108; G06Q 20/26; G06Q 20/3223

(57) ABSTRACT

A method is provided for authentication between a mobile terminal, located less than a predefined distance from the body of a user, and a processing terminal. The mobile terminal includes an antenna constituting a radio interface suitable for transmitting and receiving radio signals through the body of the user, and the processing terminal is suitable for transmitting and receiving radio signals through the body of the user. The method includes: approaching a user interface of the processing terminal with a portion of the body, triggering an activation of the processing terminal and establishing communication between the processing terminal and the mobile terminal; requesting the entering of a piece of personal authentication data; memorizing the authentication data entered; sending the authentication data through the body; receiving a result of a check of the authentication data carried out by the terminal; and checking the result.

### CROSS-REFERENCE TO RELATED APPLICATIONS

This Application is a Section 371 National Stage Application of International Application No. PCT/FR2013/051475, filed Jun. 25, 2013, which is incorporated by reference in its entirety and published as WO 2014/001704 on Jan. 3, 2014, not in English.

### FIELD OF THE DISCLOSURE

The invention relates to a method of authentication implemented by means of a mobile terminal. More precisely, the invention pertains to an authentication of a user in the course of a transaction between a mobile appliance carried by the user and a processing terminal. The mobile appliance is not exposed during this authentication and remains in the pocket, or in a bag close to the body of the user. Indeed, the authentication, carried out by a secure element inserted into the mobile terminal, uses the conducting capacities of the human body to exchange information between the processing terminal and the mobile terminal.

The invention finds a particularly beneficial application in numerous near-field communication services implemented by means of a mobile terminal and for which it is no longer necessary to expose the mobile terminal to the risk of having it stolen. Thus, such services can be used in complete security by users.

### BACKGROUND OF THE DISCLOSURE

Near-field communication technology (one customarily speaks of “NFC”, for “Near Field Communication”) is a wireless communication technology which has become widespread in recent years. Thus, a great deal of experimentation with on-mobile services based on this technology has been instigated. Mention may be made of micro-payment services, services which use dematerialized transport tickets; one customarily speaks of a “ticketing” application or “e-ticket”. For example, in the case of a ticketing service for public transport, a user equipped with an NFC mobile terminal on which an application specific to this transport service is installed, initially reloads a dedicated account. To this end, he buys a determined number of tickets and reloads this account on his mobile terminal at an NFC facility dedicated to this use. When, later, he desires to board the public transport, he brings his mobile terminal near to an NFC facility dedicated to this service and situated in the transport vehicle. The account specific to the service is then decremented by the number of ticket required to perform a journey and the user is authorized to perform the journey. However, certain services require the entry of a user authentication datum intended to prove that the user who is attempting to use the mobile terminal for a given service is indeed the legitimate owner of the terminal. This datum is for example a personal identification code, or service “PIN” code (for “Personal Identification Number”). Entry of a correct PIN code and therefore successful authentication of the user makes it possible in general to enable the application installed on the mobile terminal so that it executes. Services which require the entry of a PIN code are for example payment services, for which a certain security level is required. Security is then guaranteed by this prior authentication of the user.

Body Area Network (or Wireless Body Area Network) technology is moreover known, allowing wireless communications between miniature sensors actually on the body and a processing unit carried by the user. This technology is described in the thesis by Thomas Guthrie Zimmerman “Personal Area Networks (PAN): Near-Field Intra-Body Communication”. The applicant's patent application published under the number WO2012/131224 describes a communication device and system adapted for implementing communication through the user's body between a device carried by the user, or portable device, and a base station equipped with a sensitive surface near to which the user brings his hand or on which he places his hand so as to ensure communication between the base station and the device. The technique described in this patent application is implemented within the framework of a ticketing service. In this patent application, the base station is designed to operate according to successive continuous emission/reception cycles of predefined respective duration. Thus, for a first emission period of determined duration the base station emits a first modulated electrical signal associated with a search/interrogation message. The portable device which up until then had been in the standby state, detects and receives the first modulated electrical signal conveyed by the body of the user. The modulated signal received is demodulated by the portable device and then analyzed. The detection and reception of the first signal triggers the toggling of the portable device to emission mode for a second predefined period. The portable device then responds to the first message received by calculating a new balance of tickets and by constructing a digital response message. The digital response message is then modulated by the portable device into a second modulated electrical signal which is sent, via a radio interface of the device, through the user's body. In a following reception period, the base station then receives the second modulated electrical signal via a radio antenna. The second modulated electrical message is demodulated and its content analyzed so as to authorize or not authorize the user to board the public transport. Thus, the base station is designed to be alternately in emission mode for a first given period and in reception mode for a second given period. The device carried by the user is in a standby state until it receives a modulated electrical signal which causes it to toggle to emission mode for a given period, and then to reception mode for another given period.

The portable device and the base station comprise a modulator, a demodulator, a radio interface intended to emit and receive modulated electrical signals through the body of a user, and switching means adapted for alternately connecting the radio interface to the modulator subsequent to the reception of a modulated electrical signal and then to the demodulator subsequent to the emission of a modulated electrical signal.

In a particular exemplary embodiment, the portable device is a mobile terminal equipped with an NFC antenna, said antenna constituting the radio interface of the device, and the use of this terminal is illustrated within the framework of a ticketing service. Thus, the user can use his mobile terminal to board public transport by executing an NFC application stored on his mobile terminal, without taking his mobile terminal out of his pocket or his bag. However, when it is desired to use the device and the method in a secure NFC service, in the course of which the user is asked to enter a datum of his own, such as a PIN code, the user must take his telephone out of his bag or pocket in order to enter the PIN code on the keypad of his terminal. This exposes the user's terminal in a public place and increases the risk of theft. Thus, from the moment when authentication of the user is required, the benefit of contactless technology such as this is lost.

### SUMMARY

One of the aims of the invention is to remedy inadequacies/drawbacks of the prior art and/or to afford improvements thereto.

To this end, the invention proposes a method of authentication between a mobile terminal, situated at a distance smaller than a first predetermined distance from the body of a user, the mobile terminal comprising an antenna constituting a radio interface adapted for emitting and receiving radioelectric signals, and a processing terminal adapted for emitting and receiving radioelectric signals, the radioelectric signals being transmitted between the mobile terminal and the processing terminal using a capacity for conductivity of the body of the user, the method comprising:
a step of detecting that a part of the body of the user is situated at a distance smaller than a second predetermined distance from a user interface of the processing terminal, said detection triggering a wakeup of the processing terminal and the establishment of a communication between the processing terminal and the mobile terminal,
a step of inviting the user, by the processing terminal, to enter a personal authentication datum,
a step of sending to the mobile terminal a radioelectric signal comprising said personal authentication datum,
a step of receiving a radioelectric signal emitted by the mobile terminal comprising a datum representing the result of a verification of the personal authentication datum carried out by the mobile terminal,
a step of verifying said datum received, the authentication being successful when the verification is positive.

With the method of the invention, the authentication of the user, required for triggering the execution of an application stored on the user's mobile terminal is done without the user having to take out his mobile terminal in order to enter his personal authentication datum on the keypad of the terminal. Indeed, the personal authentication datum is entered by the user on a user interface of the processing terminal, and then transmitted by the latter to the mobile terminal which then performs the verification with a reference authentication datum previously stored on the terminal in association with the application. Thus, the mobile terminal is not exposed during the transaction with the processing terminal, since the latter remains in the user's bag or pocket. The risk of theft of the mobile terminal at the moment of entry of the personal authentication datum is therefore limited.

In a particular embodiment, the method furthermore comprises a step of storing the personal datum entered.

According to an exemplary embodiment, the verification of the personal authentication datum carried out by the mobile terminal consists in comparing the datum entered with a reference datum, stored in a secure element of the mobile terminal.

Advantageously, the antenna of the mobile terminal constituting the radio interface adapted for emitting and receiving radioelectric signals is an NFC antenna.

In this embodiment, the method proposes an authentication of transactions within the framework of NFC services implemented on the mobile terminal. NFC technology is currently undergoing rapid expansion and numerous services are envisaged or already under experimentation. The use of the method of the invention within the framework of such services allows the user to envisage such services in full confidence since the non-negligible risk of theft of his mobile terminal is removed. Moreover, the use of the service is practical and easy since the user interacts with the processing terminal by way of his own body.

According to an exemplary embodiment of the invention, the personal authentication datum entered and the datum representing the result of the verification are transmitted in a secure manner.

The secure exchange of the personal authentication datum entered by the user, and of the control datum representing the result of the verification makes it possible to strengthen the security of the service by limiting the risks of retrieval of this information by listening on the radio pathway.

In an exemplary embodiment of the invention, the invitation step consists in displaying on the user interface of the processing terminal a numerical keypad comprising digits in which the order of display of the digits is random.

The security of the bank withdrawal service is strengthened since the display of the digits of the keypad in a random order precludes anyone of ill-intention from logging the personal authentication datum by observing the user while this datum is being entered.

In another exemplary embodiment, the user interface of the processing terminal is equipped with a confidentiality filter, rendering observation by a third party impossible during entry.

The security of a service, for example a withdrawal service, is strengthened since the filter does not allow anyone situated in proximity to the user to read the screen of the processing terminal while the personal authentication datum is being entered by the user. Indeed such a filter makes it necessary to be in line with the screen in order to actually see what appears on the screen.

The invention also relates to use of the method of authentication such as previously described in a bank withdrawal service, the method furthermore comprising, after a positive verification:
an invitation step inviting the entry of an amount,
a step of storing a determined amount, chosen by the user,
a phase of dialog with a banking establishment to obtain a debit authorization,
if the debit is authorized, a step of dispensing said amount.

The method of the invention is used within the framework of a bank withdrawal service. The mobile terminal has previously stored the withdrawal application subject to authentication. The method of the invention strengthens the security of this type of service. Indeed, the user does not have to take a bank card out of his pocket or his bag, since the withdrawal application is stored on the mobile terminal. Moreover, entry of the personal authentication datum is done without the user taking his mobile terminal out of his pocket or bag. Thus, the security of this kind of service is strengthened.

In an exemplary use of the method of the invention in a bank withdrawal service, a transaction confirmation message is sent to the mobile terminal of the user.

The confirmation of the withdrawal transaction is transmitted directly to the mobile terminal by means for example of an SMS message. Thus, the user does not have to worry about retrieving and storing a paper ticket summarizing the transaction. The user can moreover process this message as he so desires. In particular he can easily archive it without risk of loss.

The invention also relates to a processing terminal comprising a radio interface designed to emit and receive radioelectric signals, the radioelectric signals being transmitted between a mobile terminal, situated at a distance smaller than a first predetermined distance from the body of a user, and the processing terminal using a capacity for conductivity of the body of the user, the processing terminal comprising:
a processing unit;
a user interface, coupled to the radio interface, designed to detect that a part of the body of the user of the mobile terminal is situated at a distance smaller than a second predetermined distance, said detection triggering a wakeup of the processing terminal and the establishment of a communication between the processing terminal and the mobile terminal,
invitation means, designed to invite the user to enter a personal authentication datum,
sending means, designed to send a radioelectric signal comprising said personal authentication datum to the mobile terminal,
reception means, designed to receive a radioelectric signal emitted by the mobile terminal comprising a datum representing the result of a verification of the personal authentication datum carried out by the mobile terminal,
verification means, designed to verify said datum received.

In a particular embodiment, the processing terminal furthermore comprises storage means, designed to store the personal authentication datum entered.

In an exemplary embodiment, the processing terminal furthermore comprises a metallic plate placed on the ground, intended to maintain the communication between the processing terminal and the mobile terminal, when a user places his feet on said plate.

The metallic plate makes it possible to maintain contact between the processing terminal and the mobile terminal of the user and to forestall any break in communication between the two entities. This element renders the use of the service more reliable.

The invention also relates to an authentication system comprising:
a processing terminal such as described previously, and
a mobile terminal adapted for emitting and receiving radioelectric signals, situated at a distance smaller than a predetermined distance from the body of a user, the electrical signals being transmitted between the mobile terminal and the processing terminal using a capacity for conductivity of the body of the user.

The invention also pertains to a program on a data medium and loadable into the internal memory of a processing terminal, the program comprising code portions for the execution of the steps of the method of authentication such as described previously, when the program is executed on said terminal.

The invention also relates to a data medium on which the computer program such as previously described is recorded.

### BRIEF DESCRIPTION OF THE DRAWINGS

Numerous details and advantages of the invention will be better understood on reading the description of a particular embodiment with reference to the appended drawings given without limiting effect, and in which:

FIG. 1 is a schematic representation of an authentication system according to a first exemplary embodiment of the invention;

FIG. 2 presents the steps of a method of authentication, according to a first exemplary embodiment;

FIG. 3 is a schematic representation of a processing terminal according to a first exemplary embodiment.

### DETAILED DESCRIPTION OF ILLUSTRATIVE EMBODIMENTS

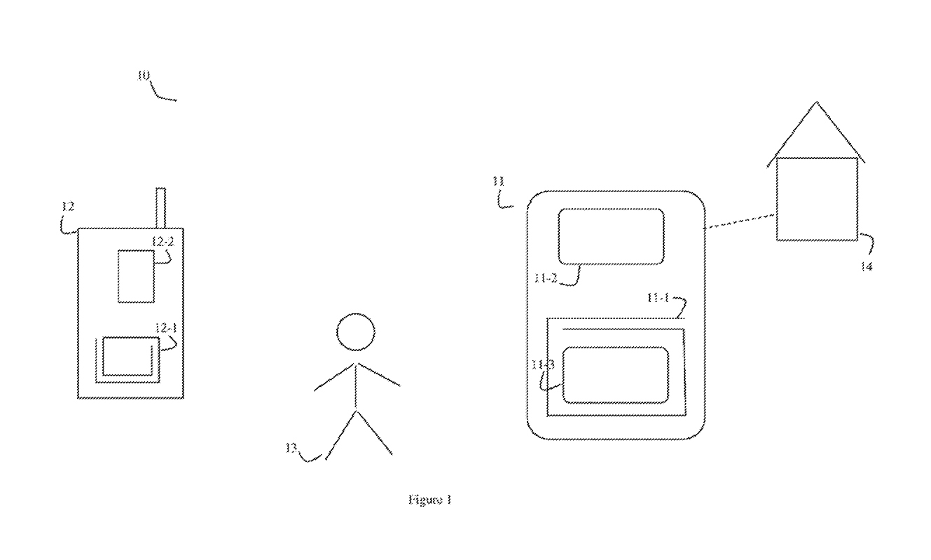

An authentication system 10 will now be described in conjunction with FIG. 1 in a particular embodiment.

The system 10 comprises a processing terminal 11 and a mobile terminal 12. A user 13, the owner of the mobile terminal 12, plays an active role in the system 10. The use of the system 10 is illustrated within the framework of a bank withdrawal service. Thus, in the exemplary embodiment described, the processing terminal 11 is a bank dispenser. The processing terminal 11 and the mobile terminal 12 are adapted for emitting and receiving radioelectric signals through the body of the user 13 via respective antennas 11-1, 12-1. Subsequently, emission through the body of the user corresponds to emission of a radioelectric signal by using a capacity for conductivity of the body of the user. Reception through the body of the user then corresponds to reception of such a radioelectric signal. In a particular embodiment, the mobile terminal 12 and the processing terminal 11 operate in accordance with the devices described in the applicant's application published under the number WO2012/131224. According to this application, a first device and a portable second device, which is carried by the user, are designed to operate according to successive continuous emission/reception cycles of predefined respective duration. Thus, for a first emission period of determined duration, the first device emits a first modulated electrical signal associated with a search/interrogation message. The second device which up until then had been in the standby state, detects and receives the first modulated electrical signal conveyed by the body of the user. The modulated signal received is demodulated by the second device and then analyzed. The detection and the reception of the first signal triggers the toggling of the second device to emission mode for a second predefined period. The second device then responds to the first message received by constructing a digital response message. The digital response message is then modulated by the second device into a second modulated electrical signal which is sent, via the antenna of the second device, through the body of the user. In a following reception period, the first device then receives the second modulated electrical signal via its radio antenna. The second modulated electrical message is demodulated and its content analyzed. Thus, the first device is designed to alternately be in emission mode for a first given period and in reception mode for a second given period. The second device, carried by the user, is in a standby state until it receives a modulated electrical signal which causes it to toggle to emission mode for a predefined period. The two devices thus exchange information by means of modulated radioelectric signals which makes it possible to implement services. The invention described in the patent application published under the number WO2012/131224 is illustrated within the framework of a service which uses dematerialized transport tickets (one customarily speaks of a “ticketing” service).

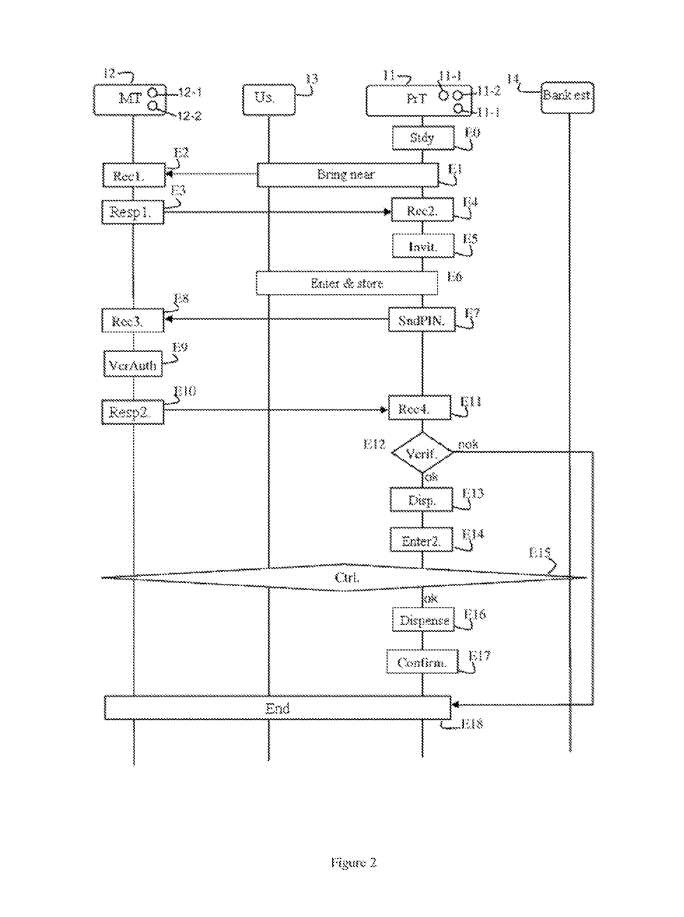

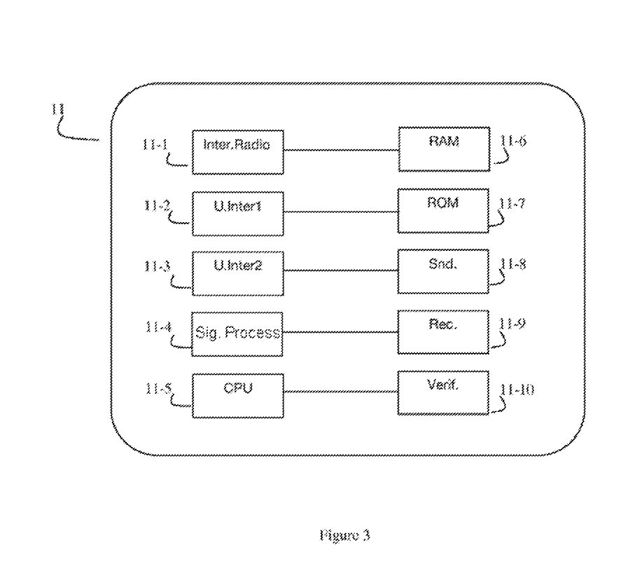

Within the framework of the present invention, the processing terminal 11 comprises a first user interface 11-2, adapted for transmitting information for the attention of the user. The first user interface 11-2 is for example a screen on which messages are displayed. In another exemplary embodiment, the first interface 11-2 is a loudspeaker adapted for disseminating voice messages. The processing terminal 11 also comprises a second user interface 11-3, adapted for receiving information from the mobile terminal 12 through the body of the user, and for transmitting information to the mobile terminal 12 through the body of the user 13. In an exemplary embodiment, the second interface 11-3 is a sensitive surface adapted for reacting when the user strokes it or is in contact with it. For example, the user can place his hand on the sensitive surface 11-3. The sensitive surface 11-3 is coupled to the antenna 11-1 and receives and transmits radioelectric signals through this antenna. The processing terminal 11 is described in greater detail in conjunction with FIG. 3. In the exemplary embodiment of the method which will be described in conjunction with FIG. 2, the processing terminal 11 is a bank dispenser connected to a remote banking establishment 14. The dispenser and the banking establishment 14 are connected by means of a specialized link, or through a network, for example the Internet network.

The mobile terminal 12 is adapted for establishing mobile communications through a mobile telecommunications network, for example a “GSM” (standing for “Global System for Mobile communications”) or “UMTS” (standing for “Universal Mobile Telecommunications System”) network, and for operating in NFC mode. Operation in NFC mode makes it possible to execute so-called NFC applications, previously installed in a secure memory area of a secure element 12-2 inserted into the terminal 12 (such an area is customarily called a “container”). The secure element is for example a “SIM” (for “Subscriber Identity Module”) card. For this purpose, the mobile terminal 12 is equipped with an NFC antenna. This NFC antenna is adapted for emitting/receiving a magnetic component of an electromagnetic wave and also an electric component of this same wave. This NFC antenna also constitutes the radio interface 12-1 adapted for emitting and receiving radioelectric signals through the body of the user 13. It is understood that in this way, the mobile terminal 12, equipped with a single NFC antenna, can at one and the same time carry out NFC transactions and also transactions through the body of the user. A secure NFC application (not represented in FIG. 1) is stored in the secure element 12-2 of the mobile terminal 12. This application is associated with a reference personal authentication datum (not represented in FIG. 1) parametrized by the user 13. The reference personal authentication datum, stored in the secure element 12-2 in association with the secure NFC application is intended to control access to said application. Thus, if the user desires to execute the secure NFC application, he is initially requested to enter the personal authentication datum associated with the application. If the authentication datum entered is identical to the reference authentication datum previously stored in the secure element, then the NFC application is executed. In the exemplary embodiment of the method which will be described in conjunction with FIG. 2, the secure NFC application is a bank withdrawal application.

The mobile terminal 12 is situated in proximity to the user 13, without necessarily being in direct contact with the latter. For example, the mobile terminal 12 is placed inside a pocket or bag carried against the user 13. In these configurations, it is estimated that the mobile terminal 12 is not further than a few centimeters away from the body of the user 13. The distance is for example less than six centimeters. A radioelectric signal emitted by the antenna 12-1 of the mobile terminal is then transmitted through the body of the user using the capacity for conductivity of the human body and is received by means of the second interface 11-3 of the processing terminal. Reciprocally, a radioelectric signal emitted by the antenna 11-1 of the processing terminal is transmitted by means of the second interface 11-3 through the body of the user using the capacity for conductivity of the human body and is received by the antenna 12-1 of the mobile terminal.

The steps of a method of authentication, according to an exemplary embodiment, will now be described in conjunction with FIG. 2.

The method of authenticating a transaction is illustrated within the framework of a bank withdrawal service. The processing terminal 11 is a dispenser which comprises as first interface 11-2 a screen and as second interface 11-3 a sensitive surface that the user can stroke or on which he can place his hand.

To perform a bank operation of withdrawal type, the user must previously authenticate himself. The aim of the authentication is to identify the user and to prove that the user is indeed the person that he purports to be. Conventionally, when a user desires to perform a bank withdrawal by means of a credit card which constitutes the secure element allowing authentication of the user, he inserts his credit card into a dispenser. The dispenser then displays a message inviting the user to enter a confidential code attached to his card. The code is presumed to be known only to the user, thereby making it possible to validate the identity of the user. The code entered is then verified locally, that is to say solely with the card, thereby making it possible to implement the financial operation between the user, more precisely his bank card via the dispenser, and a remote banking establishment. Secure exchanges are then initiated between the card and the remote banking establishment so as to authorize the withdrawal if the bank data of the user in possession of the banking establishment so allow.

In the context of the invention, the user does not have to insert his bank card into the dispenser.

In an initial standby step E0, there is displayed on the first interface 11-2, in this instance the screen of the processing terminal 11, a message inviting the user 13 to turn on his mobile terminal 12 or to ensure that the latter is turned on, and to place a part of his body, for example his hand, on the second interface 11-3, in this instance the sensitive surface of the processing terminal 11. This state E0 is an idle state in which the processing terminal 11 waits to be woken up by an action of the user. In this state the processing terminal 11 is inactive, it neither emits nor receives any data frame. The message part displayed on the screen 11-1 and relating to the mobile terminal 12 is intended to ensure that a communication can be established between the mobile terminal 12 and the processing terminal 11. Indeed, it is understood that if the mobile terminal 12 is turned off, then no communication can be established between the processing terminal 11 and the terminal 12 and the method of authentication cannot execute. It is assumed here that the user's mobile terminal 12 is turned on.

In a following step E1 of bringing near, the user 13 places his hand on the sensitive surface 11-3 of the processing terminal 11. This step E1 of bringing near is intended to trigger the wakeup of the processing terminal 11 and to establish a communication between the processing terminal 11 and the mobile terminal 12, through the body of the user 13. Contact of the user 13 with the sensitive surface 11-3 of the processing terminal 11 is detected by the processing terminal 11 and triggers the wakeup of the processing terminal 11 and the sending by this terminal of a first modulated electrical signal transporting a first data frame via the antenna 11-1 to the mobile terminal 12 through the body of the user. This frame is intended to establish a contact between the two entities. With this first signal, the processing terminal 11 signals its presence to the mobile terminal 12 and asks it to identify itself.

The establishment of a communication between two entities is carried out in a known manner in a phase customarily called a “handshake”. The handshake phase consists in exchanging several prior frames between two entities making it possible to exchange first parameters so as to permit dialog between the two entities.

In a step E2 of reception by the mobile terminal, the mobile terminal 12, in the standby state up until then, receives the first modulated electrical signal corresponding to the frame for establishing a contact, via the antenna 12-1 of the mobile terminal. This step is intended to inform the mobile terminal 12 that the communication in progress is established under NFC via the body of the user between the mobile terminal 12 and the processing terminal 11.

In a response step E3, the mobile terminal 12 sends a second modulated electrical signal corresponding to a second data frame. This second modulated electrical signal is intended to respond to the processing terminal 11 that a mobile terminal is present and that this terminal knows how to dialog with the processing terminal 11 through the body of the user, in the same language as that of the processing terminal 12.

In a step E4 of reception by the processing terminal, the processing terminal 11 receives the second modulated electrical message through the body of the user via the antenna 11-1 coupled to the sensitive surface 11-3. At this juncture, the processing terminal 11 is assured that it can dialog with the mobile terminal 12.

Steps E1 to E4 constitute the handshake phase, prior to dialog between the mobile terminal 12 and the processing terminal 11.

In a step E5 of invitation by the processing terminal, there is displayed on the screen 11-2 of the processing terminal 11 a message inviting the user 13 to enter a personal authentication datum. The personal authentication datum is associated with the bank withdrawal NFC application stored in the mobile terminal 12 and is intended to enable this application on the terminal. In a first exemplary embodiment, the personal authentication datum requested is a service “PIN” code (standing for “Personal Identification Number”). In this example, there is also displayed on the sensitive surface 11-2 of the processing terminal 11 a numerical keypad (not represented in FIG. 2).

In an entry and storage step E6, the user 13 enters his personal authentication datum. In the first example described here, he enters the PIN code associated with the bank withdrawal NFC application by means of the numerical keypad displayed on the sensitive surface 11-3 of the dispenser 11. The PIN code generally consists of four digits. Each of the digits entered by the user 13 is stored by the processing terminal 11. In an exemplary embodiment, a character of the keypad makes it possible to correct the last digit or digits entered.

Once the four digits have been entered, or after entry of a specific character marking the end of entry, the authentication datum entered and stored by the processing terminal 11 is transmitted to the mobile terminal 12 in the course of a step E7 of sending the authentication datum. The authentication datum entered is transmitted inside a third modulated electrical signal.

In a step E8 of receiving the personal authentication datum, the mobile terminal 12 receives the electrical modulated signal which transports the personal authentication datum entered by the user. The signal is demodulated, thereby allowing the mobile terminal 12 to obtain the authentication datum such as it was stored by the processing terminal 11.

In an authentication verification step E9, the authentication datum received in the course of the previous step E8 is compared with the reference personal authentication datum previously stored in the mobile terminal 12 in association with the bank withdrawal service. The reference authentication datum is stored in a secure manner, in a secure container of the secure element 12-2. Verification of authentication is positive when the datum entered is identical to the reference datum. It is negative in the converse case. In a response step E10, the mobile terminal 12 sends in a fourth modulated electrical signal a frame comprising a control datum intended to indicate the result of the authentication carried out by the secure element 12-2. For example, the control datum corresponds to the message “ok”, when the verification of the authentication performed in the course of step E9 is positive, and “nok” when the verification is negative. The control datum thus represents the result of the verification of the personal authentication datum performed by the secure element 12-2.

In a reception step E11, the processing terminal receives the control datum sent by the mobile terminal 12 in the course of step E10.

In a following verification step E12, the processing terminal 11 verifies the control datum received.

If the verification is positive (ok branch in FIG. 2), that is to say if the control datum corresponds to a positive authentication of the user 13, then in a following step E13 of display of an invitation message inviting entry of an amount, there is displayed on the screen 11-2 of the processing terminal 11 a message inviting the user 13 to enter an amount. There are also displayed on the sensitive surface 11-3 of the processing terminal 11 various possible amounts, or a numerical keypad adapted for allowing the user to enter the desired amount.

In a step E14 of entering an amount, the user 13 enters the amount that he desires to withdraw from his bank account. Either he selects a proposed amount on the sensitive surface 11-3, or he enters the amount from the keypad displayed on the sensitive surface 11-3.

In a control step E15, it is verified that the amount entered is consistent with bank data specific to the user. To this end a secure dialog is established between the secure element 12-2 inserted into the mobile terminal, more precisely the container dedicated to the bank withdrawal NFC application and the remote banking establishment 14. In this step, the banking establishment 14 verifies that the account associated with the user 13 is in credit by an amount at least greater than the amount requested.

In this case, in a following dispensing step E16, the processing terminal 11 dispenses the requested amount to the user 13.

In a confirmation step E17, the banking establishment 14 emits a confirmation message to the mobile terminal 12 of the user. This entails for example an “SMS” (standing for “Short Message Service”) confirmation message destined for the mobile terminal 12 of the user 13. This confirmation message comprises information on the transaction which has just taken place. For example, the SMS message comprises the time of the withdrawal, the name of the bank associated with the dispenser, and the amount of the withdrawal.

In a following end-of-transaction step E18, the termination of the transaction is undertaken. The processing terminal 11 sends an end-of-communication message to the mobile terminal 12, for the attention of the user 13. There is thereafter displayed on the screen 11-2 of the processing terminal 11 a message informing the user that the transaction has terminated and that he can withdraw his hand from the sensitive surface 11-2. It is understood that during steps E1 to E17 the user 13 maintains his hand on the sensitive surface 11-3 of the processing terminal 11 or still maintains it very close to this surface so as to maintain a permanent contact between the mobile terminal 12 and the processing terminal 11.

At the conclusion of the end-of-transaction step E18, the processing terminal 11 returns to the initial standby step EU.

If the verification of the control datum received performed in the course of step E12 is negative (“nok” branch in the figure), that is to say if the user authentication performed by the mobile terminal during step E9 has failed, the processing terminal 11 can terminate the transaction prematurely by going directly to the end-of-transaction step E18.

In an exemplary embodiment corresponding to the case where the personal authentication datum is a PIN code and with an aim of rendering the service yet more secure, in the course of the invitation step E5 inviting entry of a personal authentication datum, the digits are displayed on the numerical keypad in a random order. Thus, anyone who might observe the user 13 in the process of entering his code would have difficulty reconstructing the sequence on the basis of the position of the user's fingers. In another exemplary embodiment, a confidentiality filter is positioned on the sensitive surface 11-3 on which the keypad is displayed. Such a confidentiality filter is a protection which is placed in front of the sensitive surface 11-3 and which restricts vision of the data displayed on either side of the vision axis, thus making it impossible for a third party to observe the keypad during entry. The confidentiality filter is intended to make entry by the user 13 secure. Of course in another exemplary embodiment, the filter is combined with a keypad whose keys are displayed in a random order.

In another exemplary embodiment of the invention, the processing terminal 11 also comprises a metallic plate, placed at ground level, and on which the user places his feet to perform the withdrawal transaction. This metallic plate is intended to maintain a permanent communication channel between the mobile terminal 12 and the processing terminal 11 by way of the user's feet. Thus, communication between these two entities is not broken even if the user momentarily distances his hand from the sensitive surface 11-3.

With the method of the invention, the conventional use of the bank card is transposed over to the mobile terminal 12. Thus, the security inherent in the use of a bank card with personal authentication datum is strengthened on the one hand by the fact that the user 13 does not have to take his bank card out of his pocket or his bag, and on the other hand by the fact that the personal authentication datum can be entered without the user taking out his mobile terminal. Thus, the user's mobile terminal 12 is not exposed, thereby decreasing the risk of theft.

The authentication datum entered here by the user is a PIN code. The invention is of course not limited to this example. Thus, in a second exemplary embodiment, the personal authentication datum requested is a fingerprint. In this case, in the course of the invitation step E5, there is displayed on the sensitive surface 11-2 of the processing terminal 11 a determined area on which the user is invited to place his finger.

In another exemplary embodiment, the authentication datum entered is sent in a secure manner to the mobile terminal 12 in the course of the sending step E5. For example, the datum is encrypted by means of an encryption algorithm prior to its transmission. The encryption techniques are assumed known to the person skilled in the art and are not described here.

Likewise, in another exemplary embodiment, the control datum sent to the processing terminal 11 in the course of the response step E10 is transmitted in a secure manner. In this case, it is encrypted prior to its sending.

In the example described here, the user 13 places his hand on the sensitive surface 11-3. In a variant embodiment, the user 13 brings his hand near the sensitive surface 11-3 to a distance smaller than a determined distance. This determined distance does not exceed a few centimeters. Thus, the user interface 11-3 detects that a part of the body, for example the hand, is situated at a distance smaller than this determined distance.

The method of authentication is described here within the framework of a bank withdrawal service. The invention is of course not limited to this service. Thus, the method also applies to any service which relies on an application stored in the secure element 12-2 of the mobile terminal 12 and which requires user authentication. Thus, the invention applies for example also to payment services by means of the mobile terminal. The invention also applies to services related to the health sector and which require authentication prior to access to personal health data. The invention can also be applied to services controlling access to buildings, etc.

A processing terminal 11 will now be described in conjunction with FIG. 3 in a particular embodiment.

In the exemplary embodiment described in conjunction with FIG. 2, the processing terminal 11 is a bank withdrawal terminal. More generally, the processing terminal 11 is a computerized appliance, adapted for emitting and receiving information through the body of the user. To this end, it comprises:
a radio interface 11-1, designed to emit and receive modulated electrical signals transmitted through the body of the user situated at a distance smaller than a predetermined distance,
a first user interface 11-2, designed to transmit information to the user. In a first exemplary embodiment, the first user interface is a screen on which messages are displayed for the attention of the user. In another exemplary embodiment, the first interface 11-2 is a loudspeaker adapted for disseminating voice messages. The first interface 11-2 constitutes invitation means designed to invite the user to enter a personal authentication datum,
a second user interface 11-3, designed to exchange information with the mobile terminal 12 (not represented in FIG. 3) through the body of the user. For example, the second user interface 11-3 is a sensitive surface that the user can stroke or on which he can place his hand. The second interface 11-3 is coupled to the radio interface 11-1,
a unit for processing signals 11-4, which comprises a modulator designed to modulate a first digital signal into a first modulated electrical signal, a demodulator designed to demodulate a second modulated electrical signal received into a second digital signal, and switching means for connecting in an alternate manner the radio interface 11-1 to the modulator subsequent to the reception of the second modulated electrical signal, and the radio interface to the demodulator subsequent to the emission of the first modulated signal,
a processing unit or processor 11-5, or “CPU” (standing for “Central Processing Unit”), intended to load instructions into memory, to execute them, to perform operations;
a set of memories, including a volatile memory 11-6, or “RAM” (for “Random Access Memory”) used to execute code instructions, to store variables, etc., and a storage memory 11-7 of “EEPROM” type (standing for “Electrically Erasable Programmable Read Only Memory”). The storage memory 11-7 is in particular designed to store the personal authentication datum entered by the user,
sending means 11-8, designed to dispatch the personal authentication datum entered by the user by means of the second user interface 11-3 to the mobile terminal, through the body of the user,
reception means 11-9, designed to receive from the mobile terminal, through the body of the user, a datum representing the result of a verification of the personal authentication datum carried out by the terminal of the user,
verification means 11-10, designed to verify said datum received.

The user interfaces 11-2, 11-3, the processing unit 11-4, the means of sending 11-8, reception 11-9, and verification 11-10 are preferably software modules comprising software instructions for executing the steps of the above-described method of authentication.

The invention therefore also relates to:
a computer program comprising instructions for the implementation of the method of authentication such as described previously when this program is executed by a processor of the processing terminal;
a readable recording medium on which the computer program described hereinabove is recorded.

The software modules can be stored in, or transmitted by, a data medium. The latter can be a hardware storage medium, for example a CD-ROM, a magnetic diskette or a hard disk, or else a transmission medium such as a telecommunication signal or network.

The invention also relates to an authentication system which comprises a processing terminal such as described previously and a mobile terminal comprising a radio interface, adapted for emitting and receiving radioelectric signals through the body of the user.

The mobile terminal is also designed to receive a personal authentication datum, to verify it and to transmit a datum representing the result of this verification. In a particular embodiment, the mobile terminal comprises a secure element 12.2 and is designed to verify the personal authentication datum by comparing it with a reference personal authentication datum, stored in the secure element.

Although the present disclosure has been described with reference to one or more examples, workers skilled in the art will recognize that changes may be made in form and detail without departing from the scope of the disclosure and/or the appended claims.

1. A method comprising:
authentication between a mobile terminal, situated at a distance smaller than a first predetermined distance from the body of a user, the mobile terminal comprising an antenna constituting a radio interface adapted for emitting and receiving radioelectric signals, and a processing terminal adapted for emitting and receiving radioelectric signals, the radioelectric signals being transmitted between the mobile terminal and the processing terminal using a capacity for conductivity of the body of the user, the method comprising:
detecting that a part of the body of the user is situated at a distance smaller than a second predetermined distance from a user interface of the processing terminal, said detection triggering a wakeup of the processing terminal and the establishment of a communication between the processing terminal and the mobile terminal,
inviting the user, by the processing terminal, to enter a personal authentication datum,
sending to the mobile terminal a radioelectric signal comprising said personal authentication datum,
receiving a radioelectric signal emitted by the mobile terminal comprising a datum representing the result of a verification of the personal authentication datum carried out by the mobile terminal,
verifying said datum received, the authentication being successful when the verification is positive.

2. The method as claimed in claim 1, in which the verification of the personal authentication datum carried out by the mobile terminal comprises comparing the datum entered with a reference datum, stored in a secure element of the mobile terminal.

3. The method as claimed in claim 1, in which the antenna of the mobile terminal constituting the radio interface adapted for emitting and receiving radioelectric signals is an NFC antenna.

4. The method as claimed in claim 1, in which the personal authentication datum entered and the datum representing the result of the verification are transmitted in a secure manner.

5. The method as claimed in claim 1, in which the inviting comprises displaying on the user interface of the processing terminal a numerical keypad comprising digits in which the order of display of the digits is random.

6. The method as claimed in claim 5, in which the user interface of the processing terminal is equipped with a confidentiality filter, rendering observation by a third party impossible during entry.

7. The method as claimed in claim 1, further comprising:
performing the detecting, inviting, sending, receiving and verifying in a bank withdrawal service, the method furthermore comprising, after a positive verification:
inviting the entry of an amount,
storing a determined amount, chosen by the user,
a phase of dialog with a banking establishment to obtain a debit authorization,
if the debit is authorized, dispensing said amount.

8. The method of claim 7, furthermore comprising sending a transaction confirmation message to the mobile terminal.

9. A processing terminal comprising:
a radio interface configured to emit and receive radioelectric signals, the radioelectric signals being transmitted between a mobile terminal, situated at a distance smaller than a first predetermined distance from the body of a user, and the processing terminal using a capacity for conductivity of the body of the user;
a processing unit;
a user interface, coupled to the radio interface, for detecting that a part of the body of a user of the mobile terminal is situated at a distance smaller than a second predetermined distance, said detection triggering a wakeup of the processing terminal and the establishment of a communication between the processing terminal and the mobile terminal,
invitation means for inviting the user to enter a personal authentication datum,
sending means for sending a radioelectric signal comprising said personal authentication datum to the mobile terminal,
reception means for receiving a radioelectric signal emitted by the mobile terminal comprising a datum representing the result of a verification of the personal authentication datum carried out by the mobile terminal,
verification means for verifying said datum received.

10. The processing terminal as claimed in claim 9, furthermore comprising a metallic plate placed on the ground, and configured to maintain the communication between the processing terminal and the mobile terminal, when the user places the user's feet on said plate.

11. An authentication system comprising:
a processing terminal, which comprises:
a radio interface configured to emit and receive radioelectric signals, the radioelectric signals being transmitted between a mobile terminal, situated at a distance smaller than a first predetermined distance from the body of a user, and the processing terminal using a capacity for conductivity of the body of the user;
a processing unit;
a user interface, coupled to the radio interface, for detecting that a part of the body of a user of the mobile terminal is situated at a distance smaller than a second predetermined distance, said detection triggering a wakeup of the processing terminal and the establishment of a communication between the processing terminal and the mobile terminal,
invitation means for inviting the user to enter a personal authentication datum,
sending means for sending a radioelectric signal comprising said personal authentication datum to the mobile terminal,
reception means for receiving a radioelectric signal emitted by the mobile terminal comprising a datum representing the result of a verification of the personal authentication datum carried out by the mobile terminal, and
verification means for verifying said datum received; and
the mobile terminal, which is adapted for emitting and receiving radioelectric signals, situated at the distance smaller than the predetermined distance from the body of a user, the radioelectric signals being transmitted between the mobile terminal and the processing terminal using the capacity for conductivity of the body of the user.

12. (canceled)

13. A hardware data storage medium on which a computer program is recorded and comprises code portions for execution of a method of authentication, when the program is executed on a processing terminal, wherein the method comprises:
authentication between a mobile terminal, situated at a distance smaller than a first predetermined distance from the body of a user, the mobile terminal comprising an antenna constituting a radio interface adapted for emitting and receiving radioelectric signals, and the processing terminal, which is adapted for emitting and receiving radioelectric signals, the radioelectric signals being transmitted between the mobile terminal and the processing terminal using a capacity for conductivity of the body of the user, wherein authentication comprises:
detecting that a part of the body of the user is situated at a distance smaller than a second predetermined distance from a user interface of the processing terminal, said detection triggering a wakeup of the processing terminal and the establishment of a communication between the processing terminal and the mobile terminal,
inviting the user, by the processing terminal, to enter a personal authentication datum,
sending to the mobile terminal a radioelectric signal comprising said personal authentication datum,
receiving a radioelectric signal emitted by the mobile terminal comprising a datum representing the result of a verification of the personal authentication datum carried out by the mobile terminal,
verifying said datum received, the authentication being successful when the verification is positive.
